(19) United States
(12) Patent Application Publication
(10) Pub. No.: US 2024/0104578 A1
(43) Pub. Date: Mar. 28, 2024

(54) METHOD FOR ACTIVATING WARRANTY AND PRODUCT WITH A WARRANTY ACTIVATION FUNCTION

(71) Applicant: TAI GIA HUA, Khanh Hoa (VN)

(72) Inventor: TAI GIA HUA, Khanh Hoa (VN)

(73) Assignee: WELGUN TECHNOLOGY CORPORATION, HO CHI MINH (VN)

(21) Appl. No.: 18/534,585

(22) Filed: Dec. 9, 2023

(30) Foreign Application Priority Data
Dec. 12, 2022 (VN) 1-2022-08082

(51) Int. Cl. G06Q 30/012; G06K 19/06; H04W 84/12

(52) U.S. Cl. CPC G06Q 30/012; G06K 19/06037; H04W 84/12

(57) ABSTRACT

The present invention relates to a method for activating warranty comprising: providing a warranty activating unit integrated in a product which is a warranty required product; broadcasting a WiFi network with a login name and a login password identical to a login name and a password are defined according to warranty activation procedures; detecting, by the warranty activating unit, a WiFi network with the login name identical to the login name is defined according to the warranty activation procedures, when the warranty required product is powered on but its warranty has not been successfully activated, and the warranty activating unit automatically connects with the WiFi network to send a warranty activation request information to the server which is a server with a warranty activation function via the internet; the server activates a warranty and send a successful warranty activation information to the warranty required product. Said WiFi network broadcasting may be performed via an electronic device with a WiFi hotspot function. The present invention further relates to a product with a warranty activation function which may be any kind of electric or electronic devices, wherein the warranty activating unit may only turn on these devices to be operatable after their warranty have been successfully activated.

TECHNICAL FIELD

The present invention relates to a method for activating warranty, in particularly, a smart method for activating warranty for electric, electronic products, or similar products. The present invention further relates to a product with a warranty activation function.

### BACKGROUND

As already known, activating warranty for a warranty required product, for example electric, electronic devices, is the act of establishing the warranty period, by that the buyer notifies the manufacturer or distributor of the product to know the moment they start using the product is also the start of the warranty period according to the regulations of the manufacturer. Currently there are several ways to activate the warranty for electric, electronic devices as given below.

In an exemplary manner, a buyer using a warranty ticket to activate the warranty, in particular, the buyer fill in information including personal information, date of purchase, and some other relevant information to the warranty ticket, after that sending it to a warranty center of the manufacturer. This type of the warranty ticket may be made by papery and including two receipts, wherein one receipt is sent for the manufacturer, and one receipt is kept for the buyer, an electronic form (a form on a web) or an electronic email. When there is a warranty problem arising, the buyer must present the warranty ticket to the warranty center of the manufacturer to compare and validate.

Although, this method is relatively easy to do, however, there are still some disadvantages existed such as:
the buyer may delay to send the warranty ticket or write a wrong date of the purchase to benefit from the warranty period;
there may occur loss or misplacement of the warranty ticket;
the information storage system of the manufacturer may be failed, lost data;
when receiving the product for warranty purpose, it is hard for the manufacturer to check how long has the product been in use, for example how many hours, therefore it is impossible to define a warranty type according to product usage time or “warranty period” is calculated based on the total actual operating time of the product.

In another exemplary manner, the buyer uses a selling invoice to activate the warranty, in particular, the buyer receive the selling invoice issued by the seller as a role of a warranty ticket, the seller is responsible for sending selling data back to the manufacturer as a basis for the warranty. The buyer needs to keep the selling invoice, for example a paper or electronic purchase receipt form, and needs to present when a warranty issue arises.

Similar as mentioned above, this method is relatively easy to do, however, there are still some disadvantages existed such as:
some sellers may not issue the selling invoice;
there may occur loss or misplacement of the selling invoice;
the information storage system of the manufacturer may be failed, lost data;
when receiving the product for warranty purpose, it is hard for the manufacturer to check how long has the product been in use, for example how many hours, therefore it is impossible to define a warranty type according to product usage time or “warranty period” is calculated based on the total actual operating time of the product.

Yet in another exemplary manner, as for products with internet connection, for example for products such as phone, laptop, tablet. The buyer only needs to connect the device to the internet network and operates according to the instructions displayed on the user interface to send a warranty activation information via the internet network to the server of the manufacturer, then the buyer has both started to use and activated the warranty. As for this manner, usually the manufacturer installs a software or the operating system on the product which requires the user to “activate to use” or the buyer needs to perform several operations according to the instructions after starting the product to activate the product only then for it to be usable. Said activation will also activate the warranty for the device.

Although, this method is relatively easy and convenient to implement, and precise on the warranty period. However, very difficult or impossible to apply to devices without internet connection, no internet connection function, do not connect to the internet during startup/activation, or throughout the lifetime operation for example consumer electrical/electronic equipment such as air conditioning apparatus, refrigerator, water filter, electric fan, etc. Even that is difficult or impossible for devices with internet connection, for example gateway devices, modems, routers, etc., but there is no user interface for users to follow the steps to activate the warranty.

In addition, there are also a number of ways to remotely activate the warranty, for example the buyer accesses a web of the manufacturer to input a series code of the product into a web form to send a warranty activation request via the internet network, send a series number via a message according to predefined syntax to request for warranty activation via mobile network, scan a QR (Quick Response) code to send a warranty activation request via the internet network. However, these methods basically do not solve the disadvantages mentioned above well.

Therefore, there is a need for a solution to activate the warranty in a new way to better overcome the above disadvantages.

### SUMMARY

An object of the present invention is to provide method for activating warranty, may overcome one or more of the above-mentioned problems.

Another object of the present invention is to provide method for activating warranty, may activate automatically and precisely at the moment the buyer starts using the product, so that allow to implement a warranty type warranty type according to product usage time.

Yet another object of the present invention is to provide a product with a warranty activation function applied above mentioned method for activating warranty.

Various objects to be achieved by the present invention are not limited to the aforementioned objects, and those skilled in the art to which the disclosure pertains may clearly understand other objects from the following descriptions.

To achieve one or more above objects, according to an aspect, the present invention provides a method for activating warranty comprising:
providing a warranty activating unit integrated in a product which is a warranty required product, wherein the warranty activating unit including at least a storage for storing warranty activation request information and a WiFi connection part for connecting and accessing to an internet network;
broadcasting a WiFi network having a login name and a login password identical to a login name and a password that are defined according to warranty activation procedures;
detecting, by the warranty activating unit, the WiFi network with the login name identical to the login name that is defined according to the warranty activation procedures, at least when the warranty required product is powered on but its warranty has not been successfully activated, and the warranty activating unit automatically connects with the WiFi network,
wherein said warranty activating unit automatically inputs the login password identical to the password that is defined according to said warranty activation procedures to access to the internet network;
sending, by the warranty activating unit, the warranty activation request information to a server which is a server with a warranty activation function via the internet,
wherein the server generating a successful warranty activation information if the warranty activation request information is valid;
sending, by the server, the successful warranty activation information to the warranty activating unit; and
receiving and storing, by the storage of the warranty activating unit, the successful warranty activation information.

According to an embodiment, the warranty activating unit further comprising a switching controller for turning on/off a switch which allows the warranty required product to be operatable,
wherein only after said warranty activation has been successful, the switching controller turns on the switch to allow the warranty required product to operate, if said warranty activation was not successful then the switching controller does not turn on said switch, such that forcing users to activate warranty to be usable said warranty required product.

Preferably, the warranty activating unit is powered from a separate branch line from a shared power port of the warranty required product, and the warranty required product is powered from a shared power port via said switch, so that the warranty activating unit is always active when the warranty required product is connected to an external power source, meanwhile the warranty required product is powered only to operate when said switch is turned on.

Preferably, the warranty activation request information containing at least a product name, a series number, and an activation time.

Preferably, the successful warranty activation information containing at least an activation time and a warranty expiration time.

According to an embodiment, said WiFi network broadcasting is performed via an electronic device with a WiFi hotspot function.

Said electronic device with the WiFi hotspot function connects and accesses the internet network via a mobile network 3G/4G/5G or similar mobile networks.

Preferably, said server is a web server, so that allowing users be able to query warranty information or information about the product, or able to register a warranty schedule, repair, replacement, maintenance, and upkeep, or similar schedules via a web application.

Preferably, said product is attached with a QR code (Quick Response) so that users able to access the web application by scanning the QR code.

According to an embodiment, if said warranty activation has been successful, then after that when users broadcast a WiFi network with the login name and the login password identical to the login name and the password are defined according to the warranty activation procedures, the warranty activating unit will connect to the server via the internet network, and allow to send data about operation status of said product to the server.

According to another aspect, the present invention provides a product with a warranty activation function comprising:
a warranty activating unit is integrated in said product, the warranty activating unit including at least a storage for storing a warranty activation request information and a WiFi connection part for connecting and accessing to an internet network,
wherein the warranty activating unit is configured to:
detecting a WiFi network with a login name identical to a login name defined according to warranty activation procedures, at least when said product is powered on but its warranty has not been successfully activated,
automatically inputting a login password identical to a password defined according to warranty activation procedures to connect to Said WiFi network and access to the internet network;
sending a warranty activation request information to the server which is a server with a warranty activation function via the internet, and
receiving and storing, by the storage of the warranty activating unit, a successful warranty activation information, wherein the successful warranty activation information is generated by the server when the warranty activation request information is valid, and sent from the server to the warranty activating unit.

According to an embodiment, the warranty activating unit further comprising a switching controller for turning on/off a switch which allows said product to be operatable,
wherein only after said warranty activation has been successful, then the switching controller turns on the switch to allow said product to operate, if said warranty activation was not successful then the switching controller does not turn on said switch, such that forcing users to activate warranty to be usable the product.

Preferably, the warranty activating unit is powered from a separate branch line from a shared power port of said product, and the product is powered from a shared power port via said switch, so that the warranty activating unit is always active when said product is connected to an external power source, meanwhile the product is only powered to operate when said switch is turned on.

Preferably, said warranty activation request information containing at least a product name, a series number, and an activation time.

Preferably, the successful warranty activation information containing at least an activation time and a warranty expiration time.

According to an embodiment, if said warranty activation has been successful, then after that when the warranty activating unit has detected a WiFi network with the login name and the login password identical to the login name and the password are defined according to the warranty activation procedures, the warranty activating unit will connect to the server via the internet network, and allow to send data about operation status of said product to the server.

### BRIEF DESCRTPTION OF THE DRAWINGS

FIG.1 is a flow chart illustrating a method for activating warranty according to a preferred embodiment of the present invention; and

FIG.2 is a block schematic diagram illustrating a product with a warranty activation function according to a preferred embodiment of the present invention connected to the server via a WiFi hotspot device to activate the warranty; and

FIG.3 is a block schematic diagram illustrating a warranty activating unit 10′ according to a preferred embodiment of the present invention.

### DESCRIPTION OF EMBODIMENTS

Hereinafter, advantages, efficiencies, and inventive concepts of the present invention shall be understood more clearly through the detailed description of the preferred embodiments with reference to the accompanying drawings. In the drawings, same reference numbers are intended to indicate same or equivalent components or elements and commonly used in the whole description, therefore in several drawings or several parts of a drawings may not show one or more reference numbers for a purpose that makes the drawings becoming simplified and facilitating for showing composed components or different inventive concepts of the present invention, in this scenario, relationships between certain components or elements with corresponding reference numbers may be clearly illustrated when referring to other drawings or other components on the drawing. In addition, the components and elements illustrated in the drawings is not complied actual sizes and shapes, several components or elements shall be exaggerated and may be presented by simplified blocks for illustrated purposes and facilitating for descriptive purpose. Therefore, it should be understood that embodiments described herein is only exemplary for fully understanding of the inventive steps and advantages of the present invention, without any limitation of the present invention to the embodiments.

In general, the present invention aims to provide a warranty activation solution, suitable to use for electric/electronic devices, preferably devices without an internet connection, for example being operable without an internet network or no need to connect to a network, for example consumer electric/electronic devices such as air conditioners, refrigerators, water filters, electric fans. However, the present invention is not limited thereto which may be applied to any electrical/electronic equipment or product using a power source.

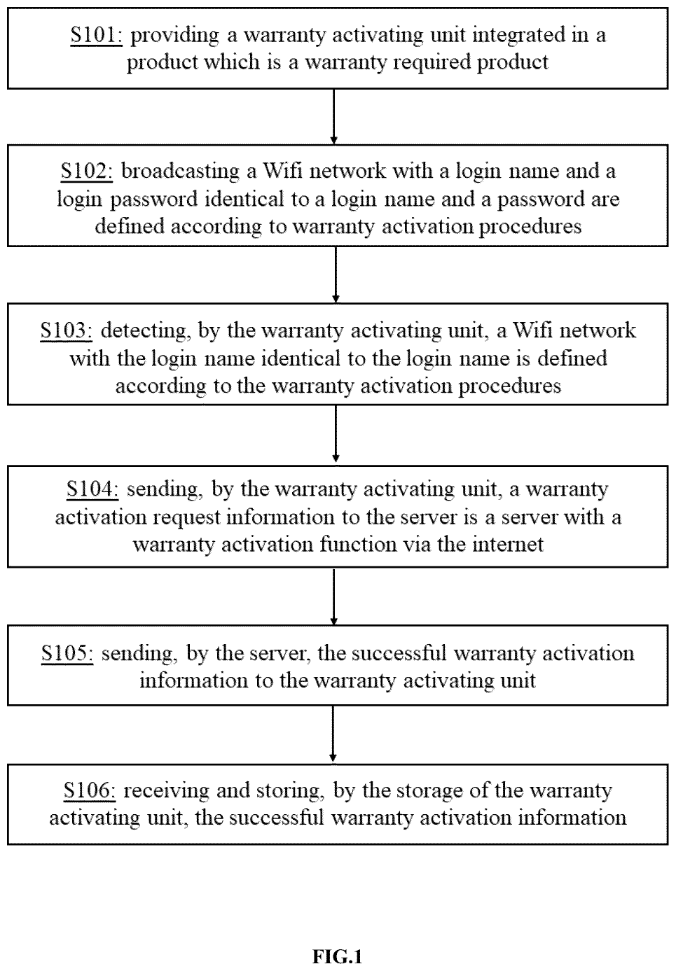

In FIG. 1 is a flow chart illustrating a method for activating warranty according to a preferred embodiment of the present invention.

As shown in the drawing, the method for activating warranty according to the embodiment substantially including the steps from step 5101 to step 5106 as described in detail below.

Step S101: providing a warranty activating unit integrated in a product which is a warranty required product.

According to the embodiment, the warranty activating unit including at least a storage for storing a warranty activation request information and a WiFi connection part for connecting and accessing to an internet network.

Step S102: broadcasting a WiFi network with a login name and a login password identical to a login name and a password are defined according to warranty activation procedures.

Step S103: detecting, by the warranty activating unit, a WiFi network with the login name identical to the login name is defined according to the warranty activation procedures.

In general, this step is performed at least when the warranty required product is powered on but its warranty has not been successfully activated. Accordingly, after the buyer buys the product, will need to supply power for the product to activate the warranty, if the warranty has not been successfully activated then the warranty activating unit will continue doing the step S103. However, the present invention is not limited thereto, the step S103 may be performed periodically during the product is operating, when the product is started, at predetermined times, or according to certain conditions (such as when users expect to register a warranty schedule, repair, replacement, maintenance, and upkeep), for example.

When detecting the WiFi network with the login name satisfied, the warranty activating unit will automatically connect to the WiFi network by automatically inputting the login password identical to the password is defined according to said warranty activation procedures to access to the internet network. Obviously, the information about the login name and the password is defined according to the warranty activation procedures are all written and stored by the manufacturer in the storage of the warranty activating unit. A software/program for automatically detecting and connecting to the WiFi network for the warranty activating unit also written and stored in the storage of the warranty activating unit. The storage may be a storage allowing read/write data, or contains a part of ROM (Read Only Memory) storage to avoid modifications, or any combination of known storage types.

Step S104: sending, by the warranty activating unit, a warranty activation request information to the server is a server with a warranty activation function via the internet. When receiving the warranty activation request, the server generates a successful warranty activation information if the warranty activation request information is valid.

Step S105: sending, by the server, the successful warranty activation information to the warranty activating unit.

Step S106: receiving and storing, by the storage of the warranty activating unit, the successful warranty activation information.

After performing the steps mentioned above of the method for activating warranty described above, the warranty activation has been completed, by this time the information related to the warranty of the product not only stored at the server, but also stored in the product during the warranty period, and even the entire life cycle of the product. So that, not only completely overcomes the problem of the situation in which invoices or warranty tickets were lost or misplaced, but also even the storage information system of the manufacturer may be failed, loss data, querying warranty information is very easy from the storage of the warranty activating unit of the product.

The warranty information is stored in the product is completely independent from the information stored at the manufacturer, may be encrypted using one of a number of specific encryption techniques to avoid modifying information. In addition, decoding or preferably decoding techniques are only performed at the server.

In the case of requesting the warranty information, for example from the manufacturer, the buyer may repeat the steps S102 and S103 above, however at this time the product has been activated the warranty successfully, therefore it will send the warranty information (or the successful warranty activation information) instead of sending the warranty activation request as described above, to the server.

According to a preferred embodiment, said WiFi network broadcasting is performed via an electronic device with a WiFi hotspot function, for example a smartphone, a tablet, or similar portable personal electronic devices. However, the present invention is not limited thereto, any manner for broadcasting a WiFi network with the login name and the login password identical to the login name and the password are defined according to the warranty activation procedures may be applied for the present invention.

In the case the electronic device is a smartphone, a tablet, or similar portable personal electronic devices, they may have an existing connection to the internet network, and implement hotspot sharing through the WiFi hotspot function. In addition, they may connect and accesses internet network via a mobile network 3G/4G/5G or similar mobile networks by using 3G/4G/5G SIM, for example. So that, the buyer can activate the warranty simply and conveniently, and can be done at any convenient location, for example at home of the buyer.

In general, said warranty activation request information contains at least a product name, a series number, and an activation time. The successful warranty activation information contains at least an activation time and a warranty expiration time. However, the present invention is not limited thereto, other information fields may be included in the warranty activation request information and the successful warranty activation information, for example the information of the buyer (name, phone, address, etc.), information about the warranty mode, information about the warranty policy for the buyer, or any kind of information due to specific situations, such as the product type or sales policy, for example.

According to a preferred embodiment, the warranty activating unit further comprises a switching controller for turning on/off a switch which allows the warranty required product to be operatable. Only after said warranty activation has been successful, then the switching controller turns on the switch to allow the warranty required product to operate, if said warranty activation was not successful then the switching controller does not turn on said switch, such that forcing users to activate warranty to be usable the said warranty required product.

The warranty activating unit may be powered from a separate branch line from a shared power port of the warranty required product, and the warranty required product is powered from a shared power port via said switch, so that the warranty activating unit is always active when the warranty required product is connected to an external power source, meanwhile the warranty required product is powered only to operate when said switch is turned on.

According to a preferred embodiment, said server is a web server, so that allowing users be able to query a warranty information or an information about the product, or able to register a warranty schedule, repair, replacement, maintenance, and upkeep, or similar schedules via a web application.

Said product may be attached with a QR code (Quick Response) so that users able to access the web application by scanning the QR code.

According to a preferred embodiment, if said warranty activation has been successful, then after that when users broadcast a WiFi network with a login name and a login password identical to the login name and the password are defined according to the warranty activation procedures, the warranty activating unit will connect to the server via the internet network, and allow to send data about operation status of said product to the server.

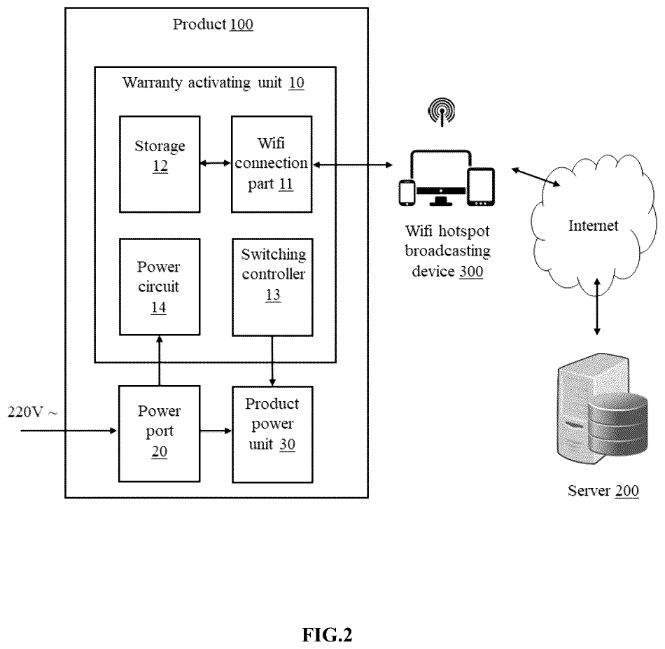

In FIG. 2 shows a product 100 with a warranty activation function according to a preferred embodiment of the present invention connected to a server 200 via a WiFi hotspot broadcasting device 300 to activate a warranty.

As shown in FIG. 2, the product 100 includes a warranty activating unit 10, a power port 20, and a product power unit 30.

The warranty activating unit 10 includes a WiFi connection part 11, a storage 12, a switching controller 13, and a power circuit 14.

The power port 20 is illustrated as supplied with a 220V AC power source. However, the present invention is not limited thereto, other commercial power source, for example 110V AC, or from converters may be applied for the present invention due to certain applications.

The server 200 may be a server system (centralization, or distribution), a server or a cloud system, or any device with similar role/function.

A WiFi hotspot broadcasting device 300 may be any electronic device with a WiFi hotspot function, for example personal handheld electronic devices such as a smartphone, a tablet, a laptop.

According to the embodiment illustrated in FIG.2, the warranty activating unit 10 integrated in the product 100, the warranty activating unit 10 is configured to:
detecting a WiFi network with a login name identical to the login name is defined according to the warranty activation procedures, at least when said product is powered on but its warranty has not been successfully activated,
automatically inputting a login password identical to the password is defined according to warranty activation procedures to connect to said WiFi network and accessing to the internet network;
sending a warranty activation request information to the server 200 is the server with a warranty activation function via the internet, and
receiving and storing, by the storage of the warranty activating unit, a successful warranty activation information,
wherein the successful warranty activation information is generated by the server 200 when the warranty activation request information is valid, and sent from the server 200 to the warranty activating unit 10.

As also shown in the drawing, the warranty activating unit 10 further comprising a switching controller 13 for turning on/off a switch which allows the product 100 to be operatable. Only after said warranty activation has been successful, then the switching controller 13 turns on the switch to allow the product 100 to operate, if said warranty activation was not successful then the switching controller 13 does not turn on said switch, such that forcing users to activate warranty to be usable the product 100 after buying it home.

The warranty activating unit 10 is powered from a separate branch line from a shared power port 20 of the product 100. A power source is supplied via the power port 20 to the power circuit 14 of the warranty activating unit 10, the power circuit 14 has the function of converting or generating appropriate power sources to supply to the electrical/electronic elements of the warranty activating unit 10. Meanwhile, the product 100 is powered from the shared power port 20 via said switch, so that the warranty activating unit 10 always active when said product is connected to an external power source, meanwhile the product 100 only powered to operate when said switch is turned on.

Said switch may be a relay included in the product power unit 30. When the relay turns on then the product power unit 30 not connected to the power port 20 and/or not supply power to the product 100 to operate. When the relay turns off the the product power unit 30 is connected to the power port 20 and/or supply power to the product 100 to operate.

According to a preferred embodiment, said warranty activation request information containing at least product name, series number, and activation time. The successful warranty activation information containing at least activation time and warranty expiration time.

According to a specific exemplarily embodiment, a product with a warranty activation function (or a warranty required product) may be an air conditioner including a warranty activating unit as described above (may be integrated during manufacturing process or additional installed after its manufacture). When the buyer buys the air conditioner, in addition to the instructions for use and other information attached with the product, warranty activation instructions may be provided. The information on the warranty activation instructions may indicate a login name of the WiFi network to activate the warranty, for example “Air conditioner warranty”, “WiFi hotspot”, “any WiFi network”, etc., and a login password for connecting to the WiFi network, for example “Warranty password”, “Hotspot password”, “Any password”, etc.

Suppose that, the WiFi network name is “Air conditioner warranty”, the password is “Warranty password”, the buyer needs to use a device with a WiFi hotspot function, for example a smartphone, able to connect to the internet network, for example via a 4G SIM, and access to the settings of the WiFi hotspot function to set the WiFi hotspot broadcasting parameters with the name is “Air conditioner warranty” and the password is “Warranty password”. Due to “Air conditioner warranty” and “Air conditioner warranty” are the login name and the password defined according to the warranty activation procedures (according to the warranty activation instructions), they are also pre-recorded and stored in the storage of the warranty activating unit of the product, when the product is powered on, the warranty activating unit will detect a network with the name is “Air conditioner warranty”, when detected, it will automatically input the password “Warranty password” which is a valid password helping the warranty required product to be connected to the internet network. Network address or similar information of the server which may be pre-defined and recorded and stored in the storage of the warranty activating unit of the product, helping the product is capable to automatically connect, send and receive data (for example through specialized software pre-installed on the product) with the server.

In practical, as for products without internet connection or operating without internet connection, for example an internet network, after activating warranty successfully, during the buyer uses the product, it is rarely that the WiFi network has a login name and a password identical to the login name and the password are defined according to the warranty activation procedures. Therefore, the product is substantially not connected to the server. However, in several cases, the buyer may be actively reset said WiFi network after said warranty activation has been successful. By this time, when the warranty activating unit detected the WiFi network with the login name and the login password identical to the login name and the password are defined according to warranty activation procedures, the warranty activating unit will connect to the server via the internet network. Because the warranty activation has been performed, the connecting between the product and the server may be used for other purposes, for example to send data about operation status of the product to the server.

It is advantage that, when arising a need of warranty, repair, replacement, maintenance, and upkeep, or the same. The buyer may no need to bring the product to a warranty center immediately, but may set a schedule in advance according to problems that arise during use, by that time the sending of data about operation status of the product to the server may support the warranty center analyzes and finds out errors/how to fix it, or prediction of recovery ability. Some situations will be convenient if remediation can be done remotely. In addition, the prediction also makes the troubleshooting process simpler, faster, and more convenient.

According to the embodiment, data related to operations, operation history, unusual operations, errors, etc., during operation of the product be recorded/processed/collected and stored in the storage in the product, such as the storage of the warranty activating unit, for example.

According to an optional embodiment, to avoid modifying the warranty information, at least data related to the warranty activation time may be encrypted, such as using a hash function to generate a reference code. For example, when activating the warranty for the product, data including product name, series number, and warranty activation time (according to the real time) will be passed through a hash function (for example, a Hash) to obtain a hash code as a reference code, this reference code may be contained within the successful warranty activation information, and stored at both the server and the corresponding product. If there are issues related to warranty, when verifying the warranty information, corresponding data related to the product name, series number, and warranty activation time will be passed through the corresponding hash function to obtain the test code, if this test code differs from the reference code that means the warranty information is inaccurate in comparison to the warranty activation time.

According to a preferred embodiment, an actual usage time of the product may be collected and stored into the storage of the warranty activating unit, so that the present invention is capable to be applied for products which attached to the warranty type according to “actual usage time” of the product, or a combination of a maximum period and an “actual usage time”. While the products are generally defined the warranty according to the maximum period, for example 6 months, 1 year, 2 years, etc., once this maximum period expires, the validity of the warranty will expire. Some products may be further defined an additional condition by “actual usage time”, if the amount of the actual usage time is greater than a predetermined value, even if the maximum period has not yet expired, the warranty will also expire.

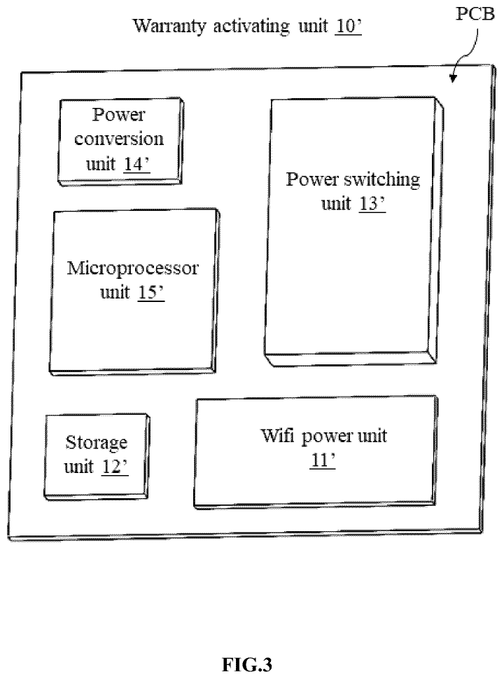

FIG. 3 shows a warranty activating unit 10′ according to a preferred embodiment of the present invention. Herein, the warranty activating unit 10′ is illustrated as a form of a module with functional components arranged on a PCB. Obviously, these functional of the warranty activating unit 10′ are not limited to be arranged on only one circuit board, but may be arranged on more than one circuit boards with electrically connection with each other. By this way, the warranty activating unit 10′ may be additionally mounted to any of products/devices which operate based on power supply, to apply the warranty method as described above in the present invention as for these products/devices. In addition, the warranty activating unit 10′ in a form of a module with functional components arranged on a PCB according to the embodiment is intended to have a relatively compact size, and does not cause significant difficulty or restrain to add to available designs of the products/devices which need to be activated warranty.

In general, the principle and operation of the warranty activating unit 10′ according to the embodiment is basically similar to the principle and operation of the warranty activating unit 10 as described in the above embodiments. Therefore, repeated descriptions are intended to be omitted to avoid redundancy. Hereafter, only basic information is given for a convenience in illustrating the invention.

As shown in FIG.3, the warranty activating unit 10′ includes a power conversion unit 14′, a microprocessor unit 15′, a storage unit 12′, a WiFi power unit 11′, and a power switching unit 13′.

The power conversion unit 14′ for converting an input power source of the device to a power source compatible with electric components in the warranty activating unit 10′. The microprocessor unit 15′ for data processing and calculating during operation of the warranty activating unit 10′. The storage unit 12′ for storing data and information during operation of the warranty activating unit 10′. The WiFi power unit 11′ to convert between data and electromagnetic radiation pulses for the warranty activating unit 10′ capable to communicate with the server via the internet network. The power switching unit 13′ to receive control pulse signals from the microprocessor unit 15′ and perform to switch supplying or cutting off the power for the device to allow the device to operate or not.

Although some embodiments have been described herein, and may accompanying with alternative or equivalent embodiments or specific exemplarily embodiment, using suitable descriptive terms and technical terms for person skilled in the art may understand and pertain the present invention. Therefore, the person skilled in the art may obviously implement modifications, equivalent arrangements, or variations based on the described embodiments. Therefore, all these modifications, equivalents, or variations fall within the protection scope of the claims appended, and the scope of the protection of the present invention is obviously not limited to contents and descripted embodiments but is defined in the following claims.

What is claimed is:

1. A method for activating warranty comprising:
providing a warranty activating unit integrated in a product which is a warranty required product, wherein the warranty activating unit including at least a storage for storing warranty activation request information and a WiFi connection part for connecting and accessing to an internet network;
broadcasting a WiFi network having a login name and a login password identical to a login name and a password that are defined according to warranty activation procedures;
detecting, by the warranty activating unit, the WiFi network with the login name identical to the login name that is defined according to the warranty activation procedures, at least when the warranty required product is powered on but its warranty has not been successfully activated, and the warranty activating unit automatically connects with the WiFi network,
wherein said warranty activating unit automatically inputs the login password identical to the password that is defined according to said warranty activation procedures to access to the internet network;
sending, by the warranty activating unit, the warranty activation request information to a server which is a server with a warranty activation function via the internet,
wherein the server generating a successful warranty activation information if the warranty activation request information is valid;
sending, by the server, the successful warranty activation information to the warranty activating unit; and
receiving and storing, by the storage of the warranty activating unit, the successful warranty activation information.

2. The method according to claim 1, wherein the warranty activating unit further comprising a switching controller for turning on/off a switch which allows the warranty required product to be operatable,
wherein only after said warranty activation has been successful, the switching controller turns on the switch to allow the warranty required product to operate, if said warranty activation was not successful then the switching controller does not turn on said switch, such that forcing users to activate warranty to be usable said warranty required product.

3. The method according to claim 2, wherein the warranty activating unit is powered from a separate branch line from a shared power port of the warranty required product, and the warranty required product is powered from a shared power port via said switch, so that the warranty activating unit is always active when the warranty required product is connected to an external power source, meanwhile the warranty required product is powered only to operate when said switch is turned on.

4. The method according to claim 1, wherein the warranty activation request information containing at least a product name, a series number, and an activation time.

5. The method according to claim 1, wherein the successful warranty activation information containing at least an activation time and a warranty expiration time.

6. The method according to claim 1, wherein said WiFi network broadcasting is performed via an electronic device with a WiFi hotspot function.

7. The method according to claim 6, wherein said electronic device with the WiFi hotspot function connects and accesses the internet network via a mobile network 3G/4G/5G or similar mobile networks.

8. The method according to claim 1, wherein said server is a web server, so that allowing users be able to query warranty information or information about the product, or able to register a warranty schedule, repair, replacement, maintenance, and upkeep, or similar schedules via a web application.

9. The method according to claim 8, wherein said product is attached with a QR code (Quick Response) so that users able to access the web application by scanning the QR code.

10. The method according to claim 1, wherein if said warranty activation has been successful, then after that when users broadcast a WiFi network with the login name and the login password identical to the login name and the password are defined according to the warranty activation procedures, the warranty activating unit will connect to the server via the internet network, and allow to send data about operation status of said product to the server.

11. A product with a warranty activation function comprising:
a warranty activating unit is integrated in said product, the warranty activating unit including at least a storage for storing a warranty activation request information and a WiFi connection part for connecting and accessing to an internet network,
wherein the warranty activating unit is configured to:
detecting a WiFi network with a login name identical to a login name defined according to warranty activation procedures, at least when said product is powered on but its warranty has not been successfully activated,
automatically inputting a login password identical to a password defined according to warranty activation procedures to connect to Said WiFi network and access to the internet network;
sending a warranty activation request information to the server which is a server with a warranty activation function via the internet, and
receiving and storing, by the storage of the warranty activating unit, a successful warranty activation information,
wherein the successful warranty activation information is generated by the server when the warranty activation request information is valid, and sent from the server to the warranty activating unit.

12. The product according to claim 11, wherein the warranty activating unit further comprising a switching controller for turning on/off a switch which allows said product to be operatable,
wherein only after said warranty activation has been successful, then the switching controller turns on the switch to allow said product to operate, if said warranty activation was not successful then the switching controller does not turn on said switch, such that forcing users to activate warranty to be usable the product.

13. The product according to claim 12, wherein the warranty activating unit is powered from a separate branch line from a shared power port of said product, and the product is powered from a shared power port via said switch, so that the warranty activating unit is always active when said product is connected to an external power source, meanwhile the product is only powered to operate when said switch is turned on.

14. The product according to claim 11, wherein said warranty activation request information containing at least a product name, a series number, and an activation time.

15. The product according to claim 11, wherein the successful warranty activation information containing at least an activation time and a warranty expiration time.

16. The product according to claim 11, wherein if said warranty activation has been successful, then after that when the warranty activating unit has detected a WiFi network with the login name and the login password identical to the login name and the password are defined according to the warranty activation procedures, the warranty activating unit will connect to the server via the internet network, and allow to send data about operation status of said product to the server.
